(19) United States
(12) Patent Application Publication
(10) Pub. No.: US 2026/0308715 A1
(43) Pub. Date: Oct. 8, 2026

(54) APPARATUS AND METHOD FOR FRACTIONATING ALLOY COMPONENTS IN RECYCLED ALLOY

(71) Applicants: HYUNDAI MOTOR COMPANY, Seoul (KR); KIA CORPORATION, Seoul (KR)

(72) Inventor: Hee-Sam Kang, Hwaseong-si (KR)

(73) Assignees: HYUNDAI MOTOR COMPANY, Seoul (KR); KIA CORPORATION, Seoul (KR)

(21) Appl. No.: 19/260,154

(22) Filed: Jul. 3, 2025

(30) Foreign Application Priority Data
Apr. 7, 2025 (KR) 10-2025-0044663

(51) Int. Cl. C22B 21/06; C22B 7/00; C22B 9/02; C22B 9/04

(52) U.S. Cl. CPC C22B 21/068; C22B 7/001; C22B 9/02; C22B 9/04

(57) ABSTRACT

An apparatus for fractionating alloy components in a recycled alloy, the apparatus includes: a distillation chamber configured to heat a molten alloy, in which an alloy to be recycled containing a first metal as a base material and a second metal is melted, to evaporate the second metal; and a first metal holding furnace connected to the distillation chamber and configured to keep warm and store a molten first metal from which the second metal has been evaporated.

### CROSS-REFERENCE TO RELATED APPLICATION

This application claims priority to Korean Patent Application No. 10-2025-0044663, filed on Apr. 7, 2025, which is incorporated herein by reference in its entirety.

### BACKGROUND OF THE DISCLOSURE

### Field of the Disclosure

The present disclosure relates to an apparatus and method for fractionating alloy components in a recycled alloy containing a blend of multiple alloy elements.

### Description of Related Art

An aluminum alloy can be formed by adding various alloy elements, such as Si, Mg, and Cu, to aluminum (Al) as a base material. Accordingly, to successfully recycle aluminum, it is crucial to ensure that the required chemical composition range is met for each alloy system.

The application and usefulness of each recycled aluminum material is determined by the type and amount of impurities that are incorporated during a process of use, recovery, and recycling, based on the original alloy system.

In particular, a recycled material that maintains its original chemical composition without the incorporation of materials from different alloy systems or impurities, or that is close to pure aluminum due to a very small amount of mixed chemical components is highly useful.

However, most recycled materials have inherent chemical compositions, and thus their utilization is limited to alloy systems of the same series; and when heterogeneous materials or impurities are added during the recycling process, downcycling into a material with lower value than the original material is inevitable.

Therefore, in recent years, research has been conducted on improving recycling efficiency using X-ray or laser-induced breakdown spectroscopy (LIBS) equipment to sort and separate aluminum recycled materials based on their chemical composition.

For example, alloy components may be sorted through the following process:
1st Shredding→Magnetic Separation→Sieving→Eddy Current (metal/plastic sorting)→1st Shredding→Magnetic Separation→Sieving & X-ray→Laser induced breakdown spectroscopy (LIBS).

However, although the sorting technology described above enables the classification and utilization of various types of recycled materials by type when the recycled materials are inevitably mixed, the sorting technology may not overcome chemical composition constraints inherent in each recycled material.

The matters described above in the related art are provided to facilitate better understanding of the background of the present disclosure, and may include aspects that are not a related art already known to those skilled in the art.

### SUMMARY OF THE DISCLOSURE

Various aspects of the present disclosure utilize alloy composition control technology based on the principle of fractional distillation to remove certain chemical components from each recycled material, thereby eliminating chemical composition constraints so as to enable cross-utilization and increase usefulness of recycled materials, and ensure diversity in recycled material blending during recycling.

An aspect provides apparatus for fractionating alloy components in a recycled alloy according to embodiments disclosed in the present disclosure, the apparatus includes: a distillation chamber configured to heat a molten alloy, in which an alloy to be recycled comprising a first metal as a base material and a second metal is melted to evaporate the second metal; and a first metal holding furnace connected to the distillation chamber and configured to keep warm and store a molten first metal from which the second metal has been evaporated.

In some embodiments, a temperature of the distillation chamber is equal to or higher than a melting point of the first metal.

In some embodiments, a temperature of the distillation chamber may be equal to or higher than 800° C. In some further embodiments the distillation chamber is configured to have a reduced pressure atmosphere, or a vacuum. In some further embodiments a vacuum level of the distillation chamber may be equal to or lower than 5×10⁻³ torr.

In some embodiments, the apparatus may further include a melting furnace configured to melt the alloy to be recycled into the molten alloy. In some embodiments, the melting furnace is in fluid communication with the distillation chamber.

In some embodiments, a temperature of the melting furnace is equal to or higher than the melting point of the first metal.

In some embodiments, a temperature of the melting furnace may be between 660° C. and 800° C.

In some embodiments, the alloy first metal may be aluminum, and the alloy second metal may include magnesium or zinc.

In some embodiments, a temperature of the first metal holding furnace may be between 660° C. and 700° C.

In some embodiments, the apparatus may further include a second metal holding furnace connected to (e.g., in fluid communication with) the distillation chamber and configured to keep warm and store the second metal.

In some embodiments, the apparatus may further include a condenser provided between the distillation chamber and the second metal holding furnace and configured to cool and/or condense the second metal.

In some embodiments, the second metal may include magnesium or zinc, and a temperature of the second metal holding furnace may be between 420° C. and 670° C.

In another aspect, the disclosure provides a method for fractionating alloy components in a recycled alloy according to embodiments disclosed in the present disclosure. In some embodiments the method comprises: melting an alloy to be recycled wherein the alloy comprises a first metal as a base material and a second metal; heating a molten alloy to evaporate the second metal; and storing a molten first metal, from which the second metal has been evaporated, in a first metal holding furnace.

In some embodiments, the alloy to be recycled may be melted at a temperature between 660° C. and 800° C.

In some embodiments, the molten alloy may be heated at a temperature of 800° C. or higher. In some embodiments the method may comprise heating the molten alloy under a reduced atmosphere such as, for example, a vacuum at pressure of 5×10⁻³ torr or lower.

In some embodiments, the first metal may be aluminum.

In some embodiments, the method may further include condensing the evaporated second metal, and may further include storing the condensed second metal in a second metal holding furnace.

In some embodiments, the second metal may be magnesium or zinc.

According to embodiments of the present disclosure, the apparatus and/or method utilizes alloy composition control technology based on the principle of fractional distillation to remove certain chemical components from each recycled material, thereby eliminating chemical composition constraints so as to enable cross-utilization and increase usefulness of recycled materials, and ensure diversity in recycled material blending during recycling.

Accordingly, applying the present disclosure to vehicle components and other mixed alloy materials may lead to significant cost saving.

### BRIEF DESCRIPTION OF THE DRAWINGS

FIG. 1 illustrates an apparatus for fractionating alloy components in a recycled alloy of the present disclosure.

FIG. 2 illustrates a method for fractionating alloy components in a recycled alloy of the present disclosure.

### DESCRIPTION OF SPECIFIC EMBODIMENTS

In order to fully understand the present disclosure, operational advantages of the same, and the objectives achieved by the implementation of the present disclosure, reference should be made to the accompanying drawings that illustrate some non-limiting preferred embodiments of the present disclosure and the associated description.

In describing various exemplary embodiments of the present disclosure, a description of known art or a repetitive description that may unnecessarily obscure the gist of the present disclosure will be shortened or omitted.

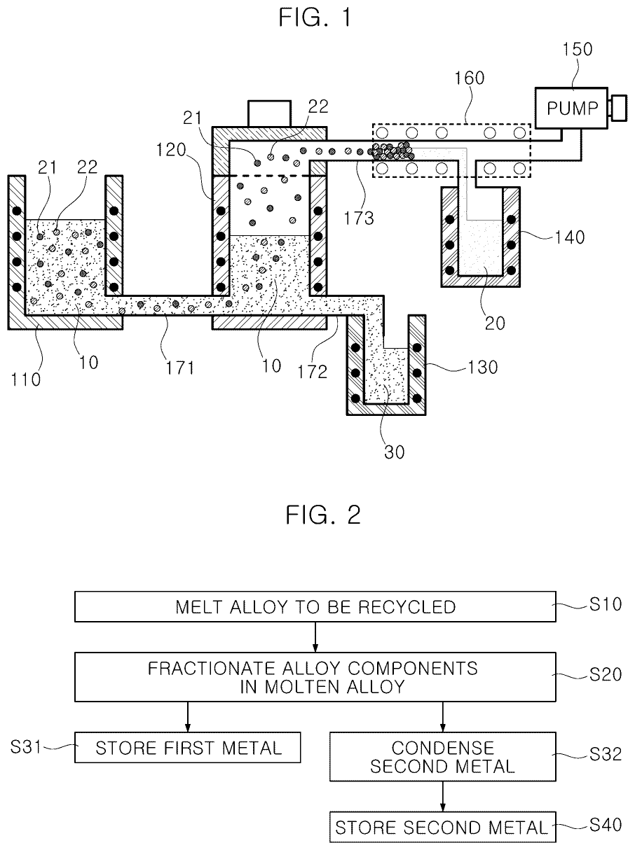

FIG. 1 illustrates an apparatus for fractionating alloy components in a recycled alloy of the present disclosure.

In one aspect, the disclosure provides an apparatus for fractionating alloy components in a recycled alloy according to an embodiment as generally depicted in, and described below with reference to, FIG. 1.

Embodiments disclosed in the present disclosure utilize alloy composition control technology based on the principle of fractional distillation to remove certain chemical components from each recycled material, thereby eliminating chemical composition constraints so as to enable cross-utilization and increase usefulness of recycled materials, and ensure diversity in recycled material blending during recycling.

As shown in Table 1 (with a content range given in % by weight), due to their high Mg and Zn content, A5000 and A7000 series alloys, which are widely used in the construction and aviation sectors, may not be mixed for use as recycled materials with casting alloys such as A356 or A319, or with wrought alloys of the A6000 series, which are commonly used in the automotive sector.

However, if the composition control technology in the embodiments disclosed in the present disclosure are used to remove Mg and Zn from the recycled alloy materials of the A5000 and A7000 series alloys that are used in non-automotive sectors, the recycled materials may be repurposed for use in the alloy systems required by the automotive sector, thereby ensuring a consistent supply of recycled materials and providing cost competitiveness through utilization as high value-added materials.

TABLE 1

| Sector | Category | Si | Fe | Cu | Mg | Zn | Cr | Mn | Note |
|---|---|---|---|---|---|---|---|---|---|
| Automotive | A356 | 6.5-7.5 | <0.2 | <0.2 | 0.2~0.45 | <0.1 | — | <0.1 | Wheel, |
| | | | | | | | | | chassis |
| | | | | | | | | | part, etc. |
| Automotive | A319 | 5.0~6.5 | <0.25 | 2.0~4.0 | 0.1-0.4 | <0.3 | — | <0.03 | Cylinder |
| | | | | | | | | | head |
| Automotive | A6082 | 0.7-1.3 | <0.5 | <0.1 | 0.6-1.2 | <0.2 | <0.25 | 0.4-1.0 | Chassis |
| | | | | | | | | | part, |
| | | | | | | | | | battery |
| | | | | | | | | | case, |
| | | | | | | | | | etc. |
| Automotive | A7H01 | <0.15 | <0.2 | 0.4-0.6 | 1.1-1.5 | 4.0-5.0 | <0.15 | 0.1-0.2 | Bumper |
| | | | | | | | | | back |
| | | | | | | | | | beam |
| Construction | A5005 | <0.3 | <0.45 | <0.05 | 0.7-1.1 | <0.2 | <0.1 | <0.2 | Usable |
| | | | | | | | | | in A356, |
| | | | | | | | | | A319, |
| | | | | | | | | | and |
| | | | | | | | | | A6082. |
| Construction | A5052 | <0.25 | <0.4 | <0.1 | 2.2-2.8 | <0.1 | 0.15-0.35 | <0.1 | Usable |
| | | | | | | | | | in A356, |
| | | | | | | | | | A319, |
| | | | | | | | | | and |
| | | | | | | | | | A6082. |
| Aviation | A7075 | <0.4 | <0.5 | 1.2-2.0 | 2.1-2.9 | 5.1-6.1 | <0.3 | <0.3 | Usable |
| | | | | | | | | | in A319 |
| | | | | | | | | | (piston |
| | | | | | | | | | material) |
| | | | | | | | | | and |
| | | | | | | | | | A6082. |

Embodiments disclosed in the present disclosure utilize an alloy composition control technology based on the principle of fractional distillation to fractionate alloy components from a recycled alloy for efficient reuse of the material.

To this end, and referring to FIG. 1, a system can comprise a melting furnace 110, a distillation chamber 120, and a first metal holding furnace 130. In some embodiments the system can further comprise any one or more of a second metal holding furnace 140, a pump 150, and/or a condenser 160.

In embodiments, a first metal corresponds to a base material of the alloy, and a second metal refers to an alloy component material other than the base material. The second metal may be a plurality of alloy components.

An example embodiment illustrates fractionating alloy components in an aluminum alloy, wherein the first metal may be aluminum as the base material, and the second metal may be magnesium (Mg) as a second-1 metal and zinc (Zn) as a second-2 metal. The second metal may be another metal component other than Mg and Zn, or may further include Mg, Zn, and another metal component (e.g., second-3 metal, second-4 metal, etc.).

The melting furnace 110 is configured and used to melt alloy scrap to be recycled into a molten alloy. As depicted in the example embodiment of FIG. 1, a molten alloy 10 comprises molten aluminum alloy, and the molten aluminum alloy contains magnesium 21 as the second-1 metal, and zinc 22 as the second-2 metal.

In embodiments, a temperature of the melting furnace 110 is preferably equal to or higher than a melting point of the first metal. In the embodiments disclosed in the present disclosure, taking into account the melting point of aluminum as an example, the temperature of the melting furnace 110 is preferably maintained between 660° C. and 800° C.; and taking into account melting efficiency and molten material quality, the temperature of the melting furnace 110 preferably does not exceed 800° C.

The molten alloy 10 melted in the melting furnace 110 flows into the distillation chamber 120 through a first conduit 171, which provides fluid communication between the melting furnace 110 and the distilling chamber 120.

The distillation chamber 120 heats the molten alloy 10 under conditions to vaporize the second metals 21 and 22, which have lower boiling points than the first metal, thereby turning the second metals 21 and 22 into vapor.

To store the fractionated first metal, a second conduit 172 is connected to a lower portion of the distillation chamber 120; and the first metal holding furnace 130 is in fluid connection to the lower portion of the distillation chamber 120 through the second conduit 172.

In embodiments, the molten aluminum, which is a molten first metal 30 fractionated by the distillation chamber 120, is transferred to the first metal holding furnace 130 to be kept warm and stored.

In some embodiments the temperature for the first metal holding furnace 130, may be equal to or higher than the melting point of the first metal. In some embodiments, the first metal holding furnace 130 preferably maintains a temperature of 660° C. or higher, and a temperature of 700° C. or lower to prevent an increase in hydrogen gas concentration in the molten material.

In some embodiments, a third conduit 173 is in fluid connection to an upper portion of the distillation chamber 120, and the second metals 21 and 22 in the vapor state are transferred through the third conduit 173.

In some embodiments, to facilitate the transfer, the pump 150 is connected to the third conduit 173, and the condenser 160 for condensing the second metals 21 and 22 in the vapor state cools the third conduit 173. The third conduit 173 may pass through the condenser 160, be in contact with the condenser 160, or be disposed adjacent to the condenser 160.

In some embodiments, the second metal holding furnace 140 for storing the condensed second metals 21 and 22 is in fluid connection to the third conduit 173.

In some embodiments, a molten second metal 20, which is a mixture of magnesium and zinc as the second metals liquefied by the condenser 160, is transferred to the second metal holding furnace 140 to be kept warm and stored.

In some embodiments, the second metal holding furnace 140 may comprise a controlled temperature that may preferably be set differently depending on the storage form of the recovered second metal.

In some embodiments, for liquid-phase storage, the controlled temperature is preferably maintained between 420° C. and 670° C., taking into account the melting points of zinc and magnesium; and for solid-phase storage, the controlled temperature is preferably maintained below 420° C., which is lower than the melting point of zinc, and may be maintained at room temperature.

In some embodiments, the distillation chamber 120 is preferably maintained at a vacuum level of 5×10⁻³ torr or lower and a temperature of 800° C. or higher. Experimental results of the amount of the residual second metal in the molten alloy 10 in this case are shown in Tables 2 to 4.

First, with regard to the effect of the vacuum level, as shown in Tables 2 and 3, Mg and Zn are efficiently removed at a vacuum level of 5×10⁻³ torr or lower, such that the alloy composition may be controlled to a level suitable for cross-use in another alloy system.

TABLE 2

| | |
|---|---|
| Zn(wt %) | Vacuum level (torr) |

| Zn(wt %) | 5 × 10⁻² | 1 × 10⁻² | 5 × 10⁻³ | 1 × 10⁻³ |
|---|---|---|---|---|
| 800° C. | 5.1 | 4.8 | 0.2 | 0.05 |
| 820° C. | 4.9 | 4.7 | 0.2 | 0.05 |

TABLE 3

| | |
|---|---|
| Mg(wt %) | Vacuum level (torr) |

| Mg(wt %) | 5 × 10⁻² | 1 × 10⁻² | 5 × 10⁻³ | 1 × 10⁻³ |
|---|---|---|---|---|
| 800° C. | 1.3 | 1.2 | 0.3 | 0.08 |
| 820° C. | 1.1 | 1.0 | 0.2 | 0.05 |

As shown in the results, magnesium and zinc are not sufficiently removed at a vacuum level above 5×10⁻³ torr, even when the temperature sufficiently rises.

In addition, with regard to the effect of the temperature, the alloy composition may be controlled to a level suitable for cross-use in another alloy system under the condition of 800° C. or higher (i.e., vacuum level: 5×10⁻³ torr).

These experimental results illustrate Mg and Zn removal from A7075 alloy scrap (Zn 5.2%, Mg 1.4%).

TABLE 4

| | Room | | | |
|---|---|---|---|---|
| | temperature | 780° C. | 800° C. | 820° C. |
| Zn(wt %) | 5.2 | 2.0 | 0.2 | 0.2 |
| Mg(wt %) | 1.4 | 0.8 | 0.3 | 0.2 |

As shown in the results, magnesium and zinc are not sufficiently removed below a temperature of 800° C., even when the vacuum level is sufficient.

Referring to FIG. 2, which illustrates a method for fractionating alloy components in a recycled alloy according to embodiments of the present disclosure. A method for fractionating alloy components in a recycled alloy of the embodiments disclosed in the present disclosure are detailed below, and certain repetitive description relating to, for example, metal examples, temperature, and pressure described above may be omitted.

At the onset of the method, an alloy to be recycled is melted in a melting furnace (S10).

In some embodiments, the alloy to be recycled may include a first metal as a base material, and a second metal other than the first metal. In some embodiments a temperature of the melting furnace is preferably equal to or higher than a melting point of the first metal.

In accordance with the example embodiments of the present disclosure, taking into account the melting point of aluminum, the temperature of the melting furnace is preferably maintained between 660° C. and 800° C.; and taking into account melting efficiency and molten material quality, the temperature of the melting furnace preferably does not exceed 800° C.

The method further comprises heating a molten alloy in a distillation chamber (S20).

Through this process, the first metal and the second metal are fractionated.

In some embodiments, the distillation chamber fractionates the first metal and the second metal by vaporizing the second metal under conditions of a higher temperature and a higher vacuum level than the temperature and vacuum in the melting furnace.

In some embodiments, a vacuum level of 5×10⁻³ torr or lower and a temperature of 800° C. or higher are preferable.

In some embodiments, the fractionated first metal is kept warm and stored in a first metal holding furnace (S31).

For the first metal holding furnace, in some embodiments, a temperature equal to or higher than the melting point of the first metal is required. In some embodiments, the first metal holding furnace preferably maintains a temperature of 660° C. or higher, and a temperature of 700° C. or lower to prevent an increase in hydrogen gas concentration in the molten material.

In some embodiments, the second metal in the vapor state is condensed by a condenser (S32).

In some embodiments, the condensed second metal is kept warm and stored in a second metal holding furnace (S40).

In some embodiments, the second metal holding furnace, a controlled temperature is preferably set differently depending on the storage form of the recovered second metal.

In the illustrated embodiments, for liquid-phase storage, the controlled temperature is preferably maintained between 420° C. and 670° C., taking into account the melting points of zinc and magnesium; and for solid-phase storage, the controlled temperature is preferably maintained below 420° C., which is lower than the melting point of zinc, and may be maintained at room temperature.

As described above, by utilizing alloy composition control technology based on the principle of fractional distillation of the present disclosure, certain chemical components may be removed from each recycled material, thereby eliminating chemical composition constraints so as to enable cross-utilization and increase usefulness of recycled materials during recycling.

Although the present disclosure has been described with reference to the illustrative drawings, it will be apparent to those skilled in the art that the present disclosure is not limited to the embodiments described herein and that various modifications and variations are possible without departing from the spirit and scope of the present disclosure. Therefore, such modifications or variations should fall within the scope of the claims of the present disclosure, and the scope of rights of the present disclosure should be construed based on the accompanying claims.

What is claimed is:

1. An apparatus for fractionating components in a recycled alloy comprising a first metal as a base material and a second metal, the apparatus comprising:
a distillation chamber configured to heat a molten recycled alloy to evaporate the second metal; and
a first metal holding furnace connected to the distillation chamber and configured to keep warm and store a molten first metal from which the second metal has been evaporated.

2. The apparatus of claim 1, wherein a temperature of the distillation chamber is configured to be heated equal to or higher than a melting point of the first metal.

3. The apparatus of claim 2, wherein the temperature of the distillation chamber is configured to be heated equal to or higher than 800° C.

4. The apparatus of claim 2, wherein a vacuum level of the distillation chamber is configured to a pressure equal to or lower than 5×10⁻³ torr.

5. The apparatus of claim 2, further comprising a melting furnace configured to melt the recycled alloy into molten alloy.

6. The apparatus of claim 5, wherein a temperature of the melting furnace is configured to be heated equal to or higher than the melting point of the first metal.

7. The apparatus of claim 6, wherein a temperature of the melting furnace is configured to be heated between 660° C. and 800° C.

8. The apparatus of claim 7, wherein the first metal is aluminum.

9. The apparatus of claim 8, wherein the second metal comprises magnesium or zinc.

10. The apparatus of claim 7, wherein a temperature of the first metal holding furnace is configured to be heated between 660° C. and 700° C.

11. The apparatus of claim 1, further comprising a second metal holding furnace connected to the distillation chamber and configured to keep warm and store the second metal.

12. The apparatus of claim 11, further comprising a condenser provided between the distillation chamber and the second metal holding furnace and configured to condense the second metal.

13. The apparatus of claim 11, wherein:
the second metal comprises magnesium or zinc, and
a temperature of the second metal holding furnace is configured to be heated between 420° C. and 670° C.

14. A method for fractionating components in an alloy comprising a first metal as a base material and a second metal, the method comprising:
melting the alloy to prepare molten alloy;
heating the molten alloy to evaporate the second metal; and
storing a molten first metal, from which the second metal has been evaporated, in a first metal holding furnace.

15. The method of claim 14, wherein the alloy is melted at a temperature between 660° C. and 800° C.

16. The method of claim 15, wherein the molten alloy is heated at a temperature of 800° C. or higher under a vacuum level of 5×10⁻³ torr or lower.

17. The method of claim 15, wherein the first metal is aluminum.

18. The method of claim 15, further comprising condensing the evaporated second metal.

19. The method of claim 18, further comprising storing the condensed second metal in a second metal holding furnace.

20. The method of claim 19, wherein the second metal is magnesium or zinc.
